(19) United States
(12) Patent Application Publication
(10) Pub. No.: US 2026/0204847 A1
(43) Pub. Date: Jul. 16, 2026

(54) STRUCTURE OF UNIVERSAL SERIAL BUS (USB) CONNECTOR

(71) Applicant: Hsien-Rong LIANG, New Taipei City (TW)

(72) Inventor: Hsien-Rong LIANG, New Taipei City (TW)

(21) Appl. No.: 19/023,385

(22) Filed: Jan. 16, 2025

(51) Int. Cl. H01R 13/70; H01R 24/60; H01R 107/00

(52) U.S. Cl. CPC H01R 13/701; H01R 24/60; H01R 2107/00

(57) ABSTRACT

A USB connector includes an outer housing, an input-side insertion portion, an output-side insertion portion, an input-side conductor group, a plurality of input-side high-speed differential signal conductor groups, a plurality of input-side power conductor groups, an output-side conductor group, a plurality of output-side high-speed differential signal conductor groups, a plurality of output-side power conductor groups, and a configuration channel circuit-interrupting block. After a counterpart connector is plugged into the input-side insertion portion at one end of the outer housing, connection of signal and electricity is made with the input-side high-speed differential signal conductor groups and the input-side power conductor groups of the input-side conductor group for being conducted out through the output-side high-speed differential signal conductor groups and the output-side power conductor groups of the output-side conductor group to achieve the function of transferring with another counterpart connector plugged to the output-side insertion portion.

### BACKGROUND OF THE INVENTION

### (a) Technical Field of the Invention

The present invention provides a structure of USB connector, which uses a simple mechanism of circuit-interrupting structure to make an E-marker IC not normally conducting and operating to thereby allow firmware updating of an electronic storage device to be performed smoothly.

### (b) Description of the Prior Art

USB Type-C, also known as USB-C, is a Universal Serial Bus (USB) hardware interface. The biggest feature of configuration is that the upper and lower ends are completely consistent, so that users are not restricted by direction and it can work when plugged in forward or reverse.

USB-C can be divided into Universal Serial Bus 4(USB4 ) and Thunderbolt 5 (TB5). The so-called USB4 requires the support of USB PD (USB Power Delivery) for power supply, and is a USB power supply extension standard that uses USB cables to provide a maximum of 100 W or 240 W power supply. The so-called TB5 has a bidirectional bandwidth of 80 Gbps per second, and a unidirectional transmission performance of up to 120 Gbps for display applications, which can be used for faster electronic storage devices and external graphics cards.

The above-mentioned USB4 and TB5 have the following problems and deficiencies when used and need to be improved:
Although USB4 and TB5 have advantages such as high-speed transmission and supply of large current, a problem derived therefrom is that it is not possible to directly perform firmware updating through the built-in drivers of Microsoft (Windows) or Apple (Mac), that is, it is not possible to transfer firmware updating to solid-state drives (SSDs) or memory card readers (hereinafter referred to as electronic storage devices). The reason is that, taking USB4 as an example, most of the electronic storage devices currently available on the market work with non-volatile memory communication protocol (NVMe) drivers. For operation in the USB4 mode, the actual operating mode is to use the system's non-volatile memory communication protocol driver to operate the electronic storage device, but because USB4 itself has an E-marker IC, and the work of the E-marker IC is to announce the material, transmission speed, and supported power of the connector transmission line. As a result, it is impossible to directly update the firmware of the electronic storage device through the system's own driver, and the system driver must be rewritten. In this way, the driver can connect to the electronic storage device to perform read and write operations to the electronic storage device. It is also possible to transfer the firmware written by the user to the electronic storage device through the driver communication protocol. However, such a rewriting process is too complicated and cumbersome, and it is not practical, and it consumes a lot of manpower and time.

### SUMMARY OF THE INVENTION

The primary objective of the present invention is to disconnect a power circuit from a configuration channel conductor group to an E-marker IC through an arrangement of a configuration channel circuit-interrupting block and a switch module, in order to make the E-marker IC not operating and thus making the system not recognize the existence of the E-marker IC, so that the built-in driver of the system can carry out updating of firmware of the electronic storage device.

A structure that the present invention adopts to achieve the above primary objective comprises an outer housing having one end including an input-side insertion portion and an opposite end including an output-side insertion portion. An input-side conductor group is arranged in an interior of the outer housing and located at the input-side insertion portion. The input-side conductor group includes a plurality of input-side high-speed differential signal conductor groups and a plurality of input-side power conductor groups. Further, an output-side conductor group is arranged in the interior of the outer housing and located at the output-side insertion portion. The output-side conductor group includes a plurality of output-side high-speed differential signal conductor groups in signal connection with the input-side high-speed differential signal conductor groups and a plurality of output-side power conductor groups in electrical connection with the input-side power conductor groups. Further, a configuration channel circuit-interrupting block is arranged in the interior of the outer housing for blocking power supply other than flowing through the input-side power conductor groups.

After a counterpart connector is plugged into the input-side insertion portion, connection of signal and electricity is made with the input-side high-speed differential signal conductor groups and the input-side power conductor groups, and the signal and electricity are conducted out through the output-side high-speed differential signal conductor groups and the output-side power conductor groups. This indicates that an E-marker IC in the counterpart connector does not operate normally due to the configuration channel circuit-interrupting block, that is the announcement information (such as transmission line material, transmission speed, and supported power) generated by the E-marker IC is blocked by the configuration channel circuit-interrupting block and cannot be read by the system. In this way, after the output-side insertion portion is connected to an electronic storage device, an operation of firmware updating can be smoothly performed on the electronic storage device.

A structure that the present invention adopts to achieve the above-mentioned another objective comprises an outer housing having one end including an output-side insertion portion. An output-side conductor group is arranged in an interior of the outer housing and located at the output-side insertion portion. The output-side conductor group includes a plurality of output-side high-speed differential signal conductor groups, a plurality of output-side power conductor groups, and a plurality of configuration channel conductor groups. Further, a configuration channel circuit-interrupting block is arranged in the interior of the outer housing and is provided with a switch module to fulfill power connecting to or disconnecting from the configuration channel conductor group according to needs. The switch module comprises a manipulation member for a user to control operation of the switch module. An E-marker IC is arranged in the interior of the outer housing and in electrical connection with the configuration channel conductor group in order to determine, by means of the switch module, whether to conduct or break power flow toward the E-marker IC.

When the USB connector according to the present invention uses the output-side insertion portion to receive a counterpart connector to plug therein, the output-side high-speed differential signal conductor groups, the output-side power conductor groups, and the configuration channel conductor group are set in operation to carry out transmission of a high-speed signal and a large current. Further, a user, with an attempt to do firmware updating to the electronic storage device, may operate the manipulation member of the switch module to disconnect the conducting circuit of the configuration channel conductor group, making the E-marker IC not operate normally. In this way, after the output-side insertion portion is connected to an electronic storage device, the operation of firmware updating to the electronic storage device can be smoothly performed.

By using the above technology, the problem of the prior art that an operation of firmware updating cannot be directly performed through a built-in driver of a system can be overcome, and the practical progress of the present invention as mentioned above can be achieved.

### BRIEF DESCRIPTION OF THE DRAWINGS

FIG. 1 is a perspective view of a first embodiment.

FIG. 2 is a plan view of an input-side insertion portion of the first embodiment.

FIG. 3 s a plan view of an output-side insertion portion of the first embodiment.

FIG. 4 is a first schematic view showing implementation of the first embodiment.

FIG. 5 is a second schematic view showing implementation of the first embodiment.

FIG. 6 is a first perspective view of a second embodiment.

FIG. 6A a second perspective view of the second embodiment.

FIG. 7 is a perspective view of a third embodiment.

FIG. 8 is schematic view showing switching operation of the third embodiment.

FIG. 9 is a perspective view of a fourth embodiment.

FIG. 10 is a conducting circuit diagram of the fourth embodiment.

FIG. 11 is a blocking circuit diagram of the fourth embodiment.

### DETAILED DESCRIPTION OF THE PREFERRED EMBODIMENTS

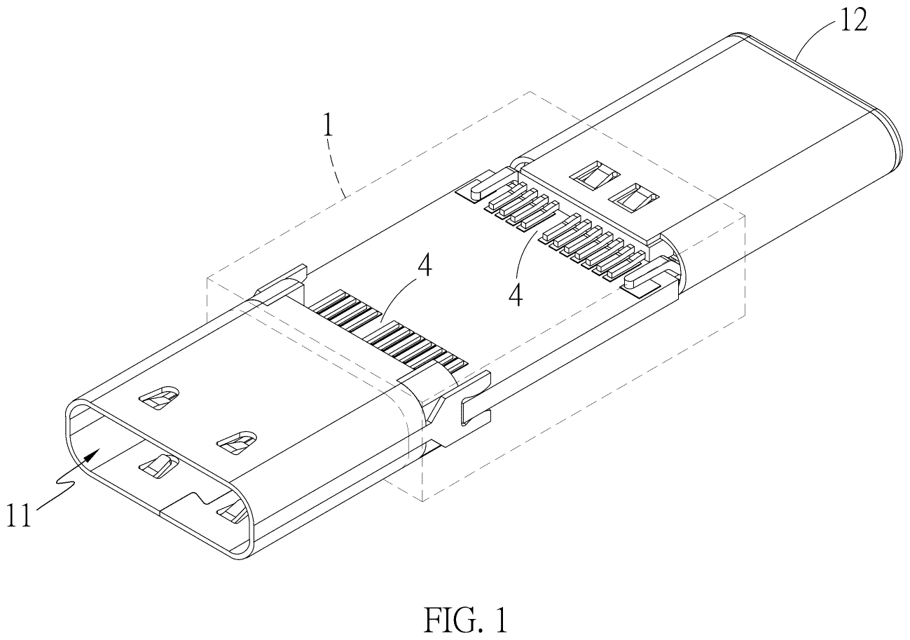

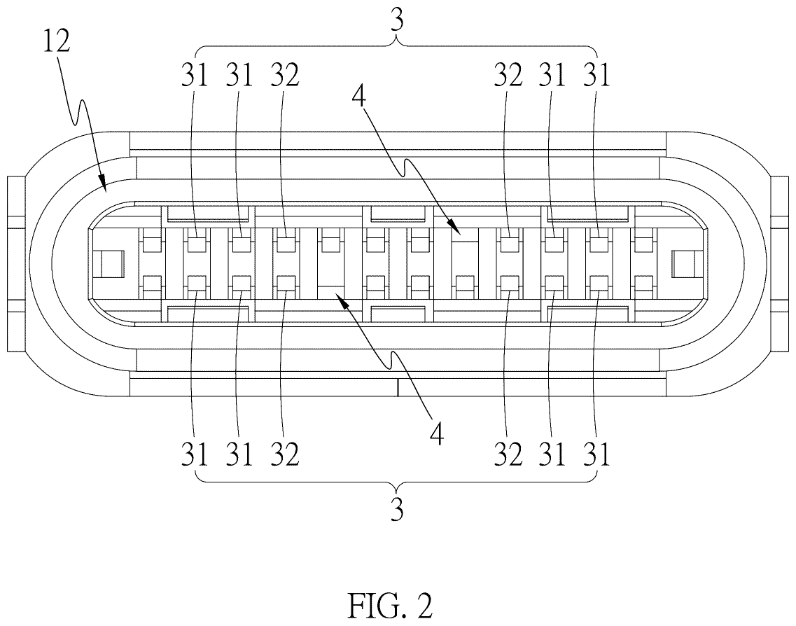

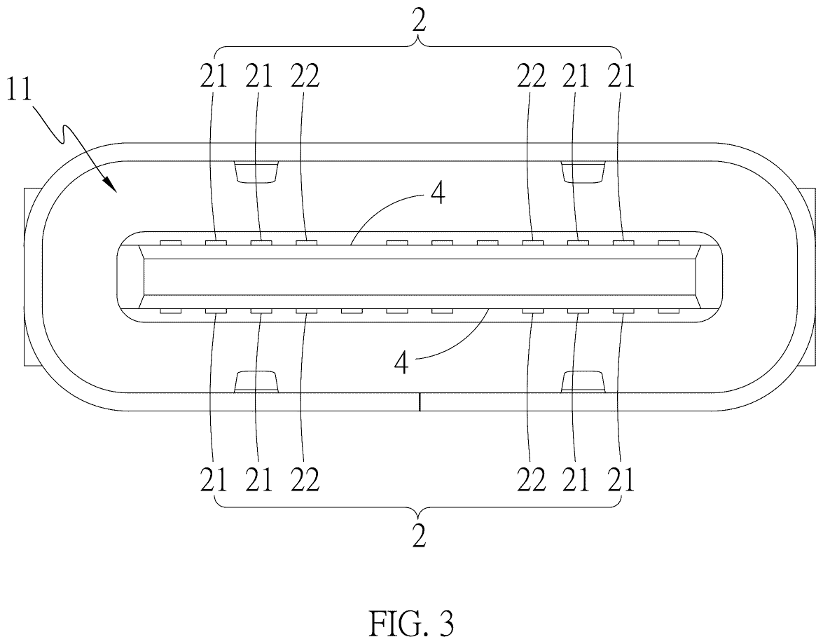

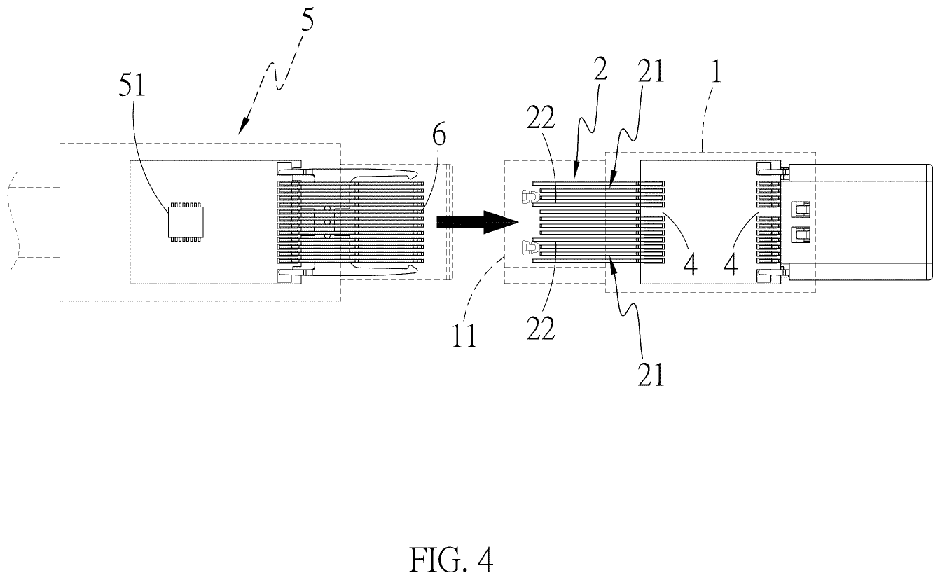

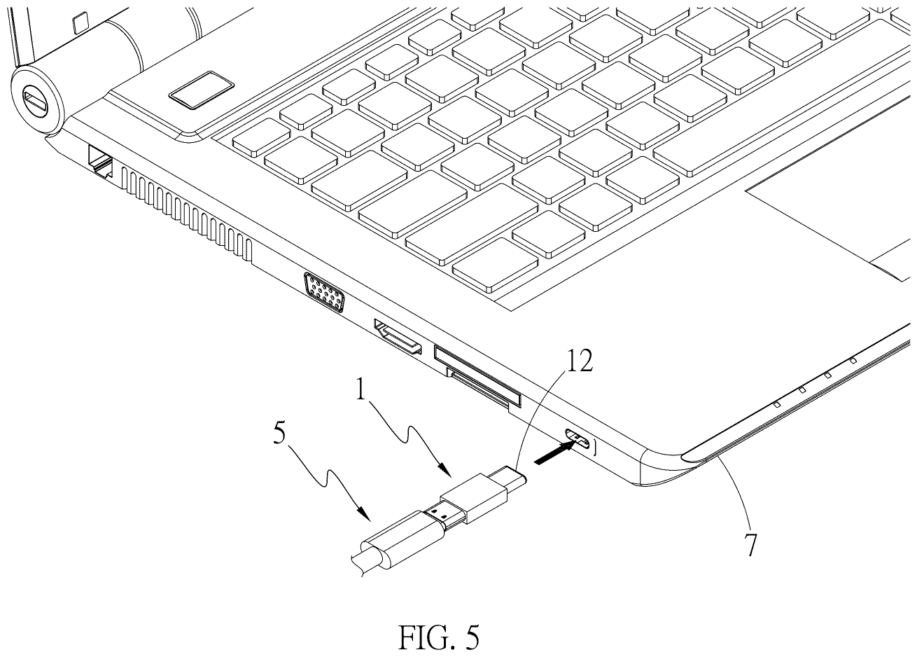

As shown in FIGS. 1-5, a structure according to the present invention comprises:
an outer housing 1, which has one end that includes an input-side insertion portion 11 and an opposite end that includes an output-side insertion portion 12;
an input-side conductor group 2, which is arranged in an interior of the outer housing 1 and located at the input-side insertion portion 11 and includes a plurality of input-side high-speed differential signal conductor groups 21 and a plurality of input-side power conductor groups 22 arranged between the input-side high-speed differential signal conductor groups 21;

an output-side conductor group 3, which is arranged in the interior of the outer housing 1 and located at the output-side insertion portion 12 and includes a plurality of output-side high-speed differential signal conductor groups 31 in signal connection with the input-side high-speed differential signal conductor groups 21 and a plurality of output-side power conductor groups 32 in electrical connection with the input-side power conductor groups 22; and
a plurality of configuration channel circuit-interrupting blocks 4, which are arranged in the interior of the outer housing 1 for blocking power supply other than flowing through the input-side power conductor groups 22.

The input-side insertion portion 11 is arranged to receive a counterpart connector 5 to insert therein. The counterpart connector 5 is one of USB4 and TB5 (Thunderbolt 5).

The input-side insertion portion 11 is an insertion opening in the instant embodiment.

The output-side insertion portion 12 is a protruded body.

The input-side conductor group 2, the input-side high-speed differential signal conductor groups 21, and the input-side power conductor groups 22 are each a plate-like conductive metal in the instant embodiment, so as to form a female configuration.

The output-side conductor group 3, the output-side high-speed differential signal conductor groups 31, and the output-side power conductor groups 32 are each an elastic conductive metal in the instant embodiment, so as to form a male configuration.

Each of the configuration channel circuit-interrupting blocks 4 is a non-conducting region and may comprises a plastic material.

When the counterpart connector 5 is plugged into the input-side insertion portion 11 of the outer housing 1, signal and electrical connections are made with the input-side high-speed differential signal conductor groups 21 and the input-side power conductor groups 22 of the input-side conductor group 2, respectively. Signals are conducted out through the output-side high-speed differential signal conductor groups 31, and power is conducted out through the output-side power conductor groups 32. It is worth mentioning that the counterpart connector 5 is provided with an E-marker IC 51, and the E-marker IC 51 is in electrical connection with a plurality of configuration channel conductor groups 6 (which are in the form of terminals or bare copper regions). This indicates that the configuration channel conductor groups 6 of the counterpart connector 5 are brought into contact with the configuration channel circuit-interrupting blocks 4; however, the configuration channel circuit-interrupting blocks 4 are non-conducting regions, so that due to no supply flow, the E-marker IC 51 fails to operate normally. Therefore, the E-marker IC 51 does not generate announcement information (such as transmission line material, transmission speed, and supported power), and the system cannot read the announcement information. This is equivalent to downgrading the counterpart connector 5 from the original USB4 specification to the USB3 specification. In this way, after the output-side insertion portion 12 is set in connection with an electronic storage device 7, the system may directly use the built-in driver to proceed with a firmware updating operation on the electronic storage device 7. In the instant embodiment, the electronic storage device 7 can be one of a personal computer (PC), a Macintosh (Mac), and a notebook computer (NB).

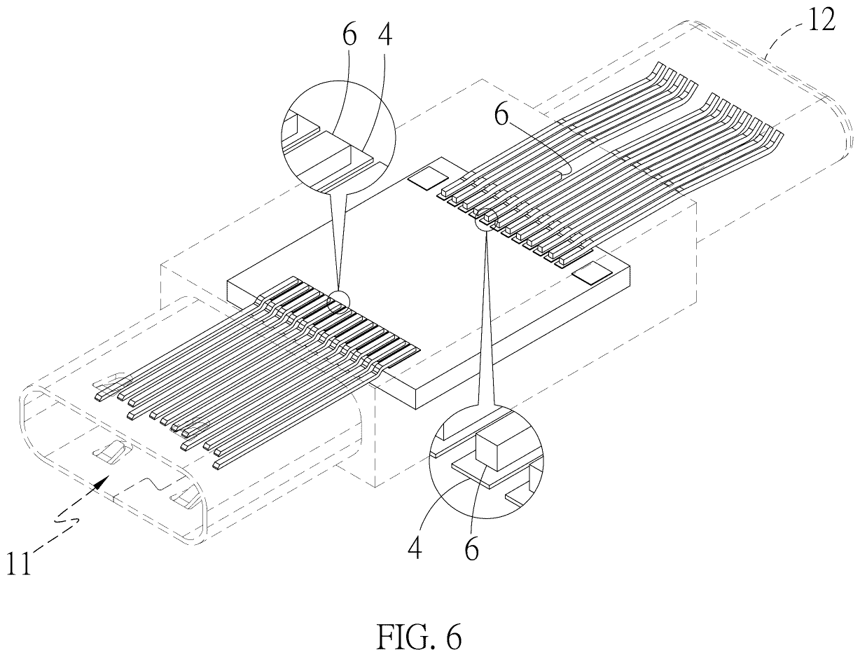

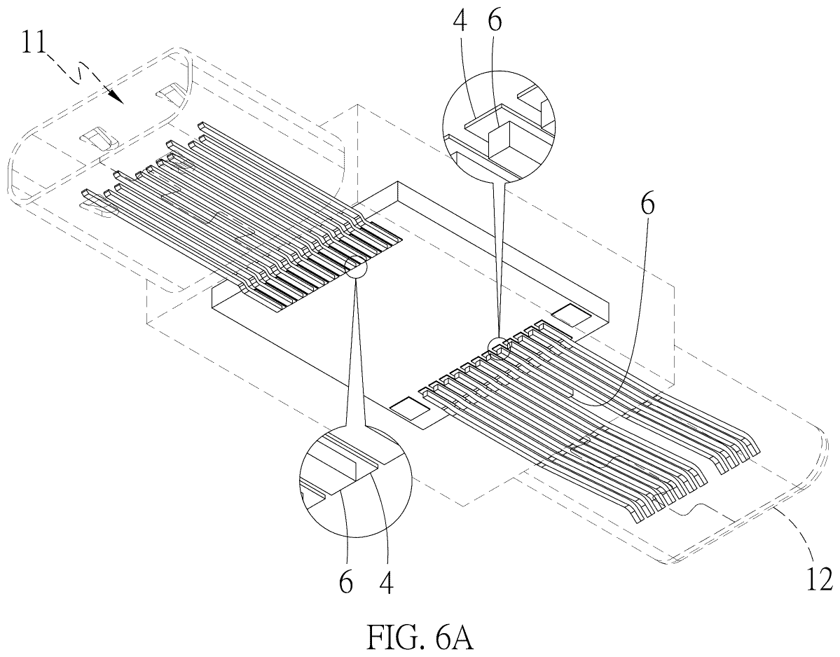

As shown in FIGS. 6 and 6A, a plurality of configuration channel circuit-interrupting blocks 4 are respectively arranged at two sides that are opposite to each other and are each provided with a configuration channel conductor group 6 arranged thereon, and the configuration channel conductor group 6 has one end that is adjacent to the input-side insertion portion 11 and an opposite end that is distant from the output-side insertion portion 12, so that the counterpart connector may contact the configuration channel conductor group 6 but not conducting, that is, the E-marker IC is not conducting due to the configuration channel conductor group 6, and the E-marker IC has no power flowing therethrough and does not normally operate. This also shuts down the operation of the E-marker IC to allow a user to directly use the built-in driver to carry out an updating operation on the electronic storage device.

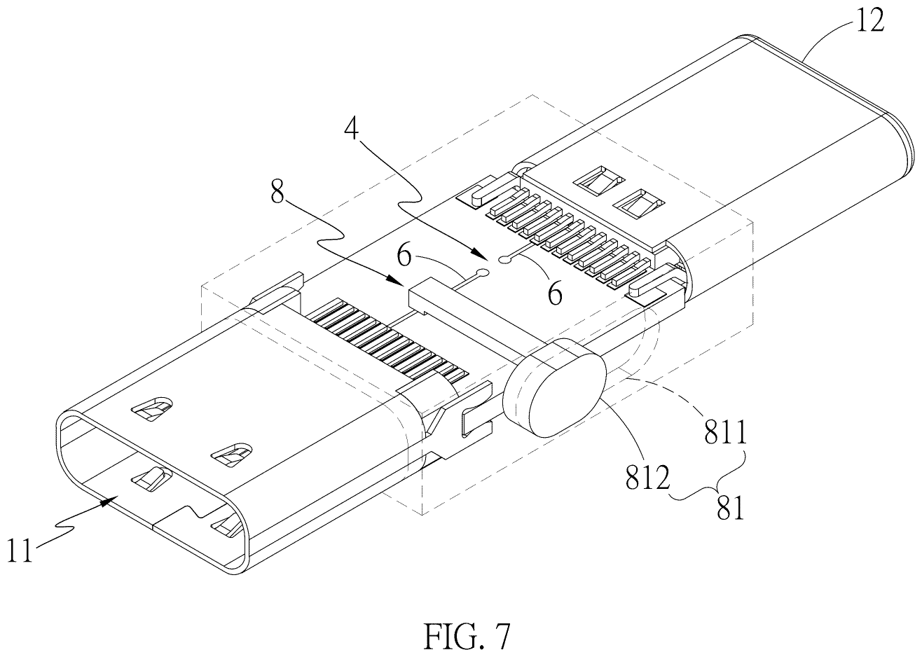

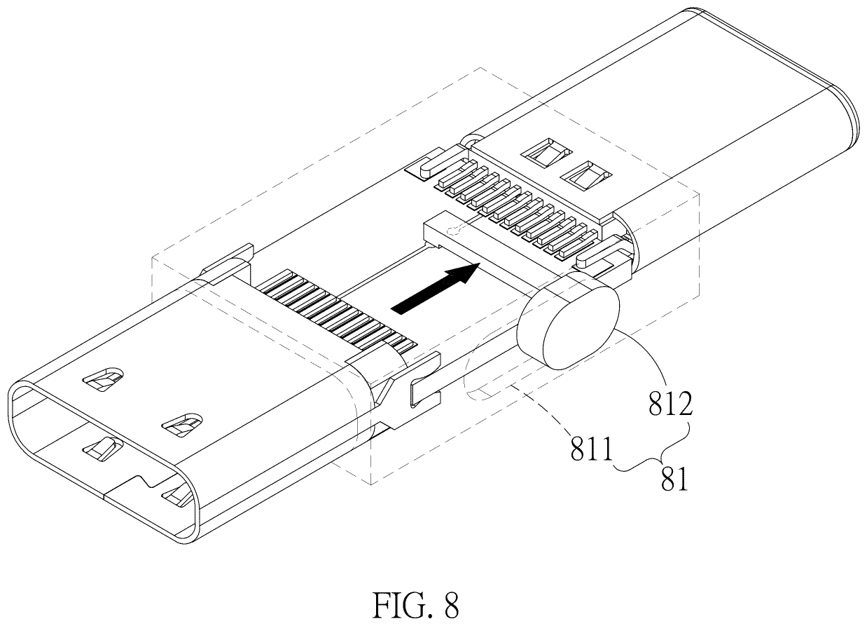

As shown in FIGS. 7 and 8, the configuration channel circuit-interrupting blocks 4 are provided with a configuration channel conductor group 6 arranged thereon, and a switch module 8 is arranged on the configuration channel circuit-interrupting blocks 4 to fulfill power connecting to or disconnecting from the configuration channel conductor group 6 according to needs. The switch module 8 comprises a manipulation member 81 which allows a user to control operation of the switch module 8. The manipulation member 81 is one of a sliding switch and a pressing switch. In the instant, the sliding switch is taken as an example for illustrating the manipulation member 81. The sliding switch of the manipulation member 81 includes a slide slot 811 and a switch 812 movably received in the slide slot 811. The switch 812 is connected to the switch module 8. In this way, the user may plug the counterpart connector (USB4 or TB5) in the input-side insertion portion 11 for a long term, and when it needs to perform high-speed signal transmission with the counterpart connector, the connection between the output-side insertion portion 12 and the electronic storage device can be used directly, and when the user wishes to do firmware updating to the electronic storage device, the user only needs to push the switch 812 to have the switch 812 moved in the slide slot 811 so as to allow the switch module 8 to switch the configuration channel conductor groups 6 from an original, non-conducting state to a conducting state. In the non-conducting state, the E-marker IC does not normally operate due to no power flow therethrough, and consequently, the E-marker IC does not generate the announcement information (such as transmission line material, transmission speed, and supported power), and the system does not read the announcement information, this being equivalent to downgrading the counterpart connector from the original USB4 specification to the USB3 specification and as such, after the output-side insertion portion 12 is connected to the electronic storage device, the system may directly use the built-in driver to perform the firmware updating operation to the electronic storage device, achieving the function of switching to USB4 or USB3 or the function of switching to TB5 or TB4, as desired by the user, making it very convenient overall.

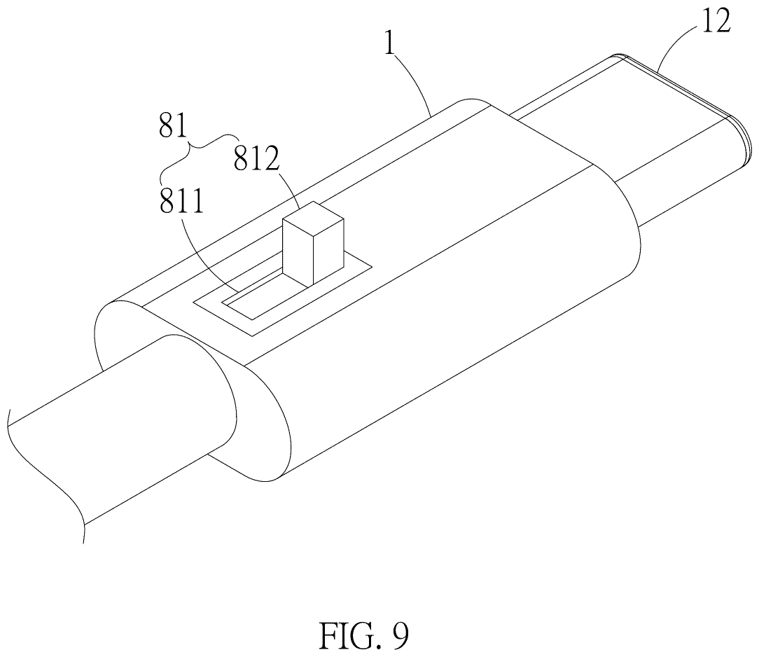

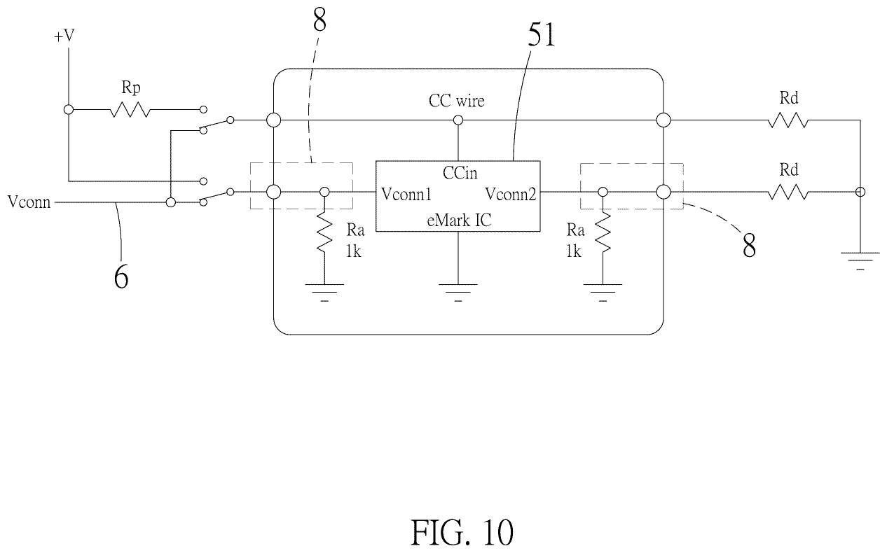

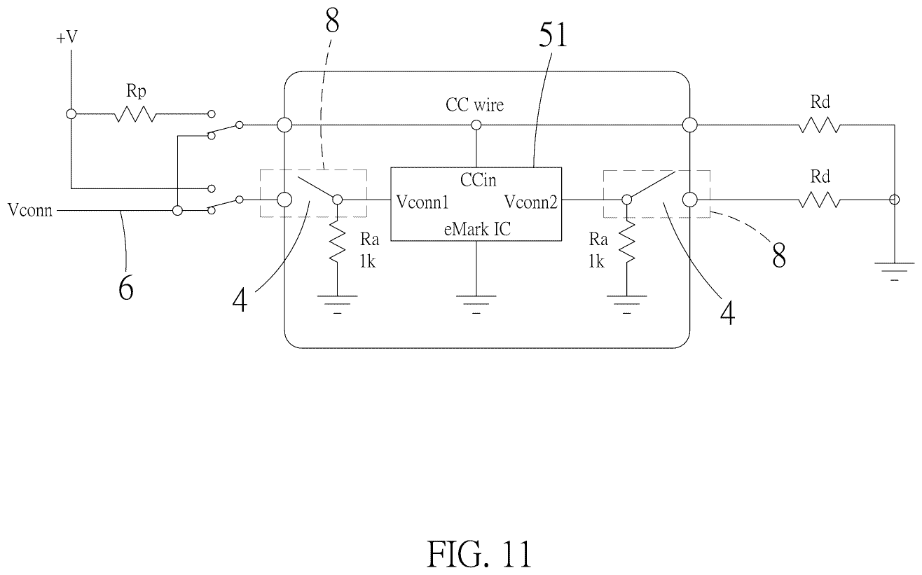

As shown in FIGS. 9-11, a structure according to the present invention comprises:
an outer housing 1, which has one end that includes an output-side insertion portion 12;
an output-side conductor group, which is arranged in an interior of the outer housing 1 and located at the output-side insertion portion 12 and includes a plurality of output-side high-speed differential signal conductor groups, a plurality of output-side power conductor groups arranged between the output-side high-speed differential signal conductor groups, and a plurality of configuration channel (CC) conductor groups 6 arranged at one side of the output-side power conductor groups;
a plurality of configuration channel circuit-interrupting blocks 4, which are arranged in the interior of the outer housing 1 and are disposed on the configuration channel conductor groups 6, a switch module 8 being arranged on the configuration channel circuit-interrupting blocks 4 to fulfill power connecting to or disconnecting from the configuration channel conductor groups 6 according to needs;
a manipulation member 81, which is arranged on the switch module 8 for allowing a user to control operation of the switch module 8; and
an E-marker IC 51, which is arranged in the interior of the outer housing 1 and are in electrical connection with the configuration channel conductor groups 6, in order to determine, by means of the switch module 8, whether to conduct or break power flow toward the E-marker IC 51.

The output-side insertion portion 12 is arranged to receive a counterpart connector to plug therein, and the counterpart connector and the output-side conductor group are compliant with a connector communication protocol of one of USB4 and TB5 (Thunderbolt 5).

The manipulation member 81 comprises one of a sliding switch and a pressing switch.

In the case of a sliding switch, the manipulation member 81 includes a slide slot 811 and a switch 812 movably arranged on the slide slot 811, and the switch 812 is connected to the switch module 8. The sliding switch is adopted as an example of the instant embodiment.

The output-side insertion portion 12 is a protruded body.

The output-side conductor group, the output-side high-speed differential signal conductor groups, the output-side power conductor groups, and the configuration channel conductor groups 6 are each an elastic conductive metal in the instant embodiment, so as to form a male configuration.

Each of the configuration channel circuit-interrupting blocks 4 is a non-conducting region.

The switch module 8 is a circuit switch.

When an attempt to use the counterpart connector to do high-speed signal transmission, a user may directly use the connection between the output-side insertion portion 12 and the electronic storage device and utilize the E-marker IC 51 to achieve the function of USB4 based transmission, and when attempting to do firmware updating for the electronic storage device, the user only needs to push the switch 812 to have the switch 812 moved on the slide slot 811 so as to allow the switch module 8 to switch the configuration channel conductor groups 6 from an original, conducting state to a non-conducting state. In the non-conducting state, the E-marker IC 51 does not normally operate due to no power flow therethrough, and consequently, the E-marker IC 51 does not generate the announcement information (such as transmission line material, transmission speed, and supported power), and the system does not read the announcement information, this being equivalent to downgrading the counterpart connector from the original USB4 specification to the USB3 specification and as such, after the output-side insertion portion 12 is connected to the electronic storage device, the system may directly use the built-in driver to perform the firmware updating operation to the electronic storage device, achieving the function of switching to USB4 or USB3 or the function of switching to TB5 or TB4, as desired by the user, making it very convenient overall.

I claim:

1. A structure of universal serial bus (USB) connector, the USB connector comprising:
an outer housing, which has one end that includes an input-side insertion portion and an opposite end that includes an output-side insertion portion;
an input-side conductor group, which is arranged in an interior of the outer housing and located at the input-side insertion portion and includes a plurality of input-side high-speed differential signal conductor groups and a plurality of input-side power conductor groups arranged between the input-side high-speed differential signal conductor groups;
an output-side conductor group, which is arranged in the interior of the outer housing and located at the output-side insertion portion and includes a plurality of output-side high-speed differential signal conductor groups in signal connection with the input-side high-speed differential signal conductor groups, and a plurality of output-side power conductor groups in electrical connection with the input-side power conductor groups; and
a plurality of configuration channel circuit-interrupting blocks which are arranged in the interior of the outer housing for blocking power supply other than flowing through the input-side power conductor groups.

2. The structure of USB connector according to claim 1, wherein the input-side insertion portion is arranged for receiving a counterpart connector to plug therein, and the counterpart connector is one of USB4 and TB5 (Thunderbolt 5).

3. The structure of USB connector according to claim 2, wherein each of the configuration channel circuit-interrupting blocks is provided with a configuration channel conductor group arranged thereon, and one end of the configuration channel conductor group is adjacent to the input-side insertion portion and other end is distant from the output-side insertion portion, so as to have the counterpart connector contacting with the configuration channel conductor groups but not conducting.

4. The structure of USB connector according to claim 1, wherein each of the configuration channel circuit-interrupting blocks is provided with a configuration channel conductor group arranged thereon, and a switch module is arranged on the configuration channel circuit-interrupting blocks to fulfill power connecting to or disconnecting from the configuration channel conductor groups, the switch module comprising a manipulation member for allowing a user to control operation of the switch module.

5. The structure of USB connector according to claim 4, wherein the manipulation member comprises one of a sliding switch and a pressing switch.

6. The structure of USB connector according to claim 5, wherein the manipulation member comprises the sliding the switch and includes a slide slot and a switch movably arranged in the slide slot, the switch being connected to the switch module.

7. A structure of USB connector, comprising:
an outer housing, which has one end that includes an output-side insertion portion;
an output-side conductor group, which is arranged in an interior of the outer housing and located at the output-side insertion portion and includes a plurality of output-side high-speed differential signal conductor groups, a plurality of output-side power conductor groups arranged between the output-side high-speed differential signal conductor groups, and a plurality of configuration channel conductor groups arranged at one side of the output-side power conductor groups;
a plurality of configuration channel circuit-interrupting blocks, which are arranged in the interior of the outer housing and are disposed on the configuration channel conductor groups, a switch module being arranged on the configuration channel circuit-interrupting blocks to fulfill power connecting to or disconnecting from the configuration channel conductor groups according to needs;
a manipulation member, which is arranged on the switch module for allowing a user to control operation of the switch module; and
an E-marker IC, which is arranged in the interior of the outer housing and are in electrical connection with the configuration channel conductor groups, in order to determine, by means of the switch module, whether to conduct or break power flow toward the E-marker IC.

8. The structure of USB connector according to claim 7, wherein the output-side insertion portion is arranged for receiving a counterpart connector to plug therein, and the counterpart connector and the output-side conductor group are compliant with a connector communication protocol of one of USB4 and TB5 (Thunderbolt 5).

9. The structure of USB connector according to claim 7, wherein the manipulation member comprises one of a sliding switch and a pressing switch.

10. The structure of USB connector according to claim 9, wherein the manipulation member comprises the sliding the switch and includes a slide slot and a switch movably arranged in the slide slot, the switch being connected to the switch module.
